(19) United States
(12) Patent Application Publication
(10) Pub. No.: US 2017/0101901 A1
(43) Pub. Date: Apr. 13, 2017

(54) METHOD FOR OPERATING A STEAM TURBINE

(71) Applicant: Siemens Aktiengesellschaft, Munich (DE)

(72) Inventors: Jan Greis, Duisburg (DE); Tobias Rühle, Essen (DE); Steffen Wendt, Essen (DE)

(73) Assignee: Siemens Aktiengesellschaft, Munich (DE)

(21) Appl. No.: 15/129,474

(22) PCT Filed: Mar. 25, 2015
(86) PCT No.: PCT/EP2015/056345

§ 371 Date: Sep. 27, 2016

(30) Foreign Application Priority Data
Apr. 7, 2014 (EP) 14163721.5

(51) Int. Cl. F01K 23/16; F01D 15/10; F01K 13/02; F01K 7/16

(52) U.S. Cl. CPC F01K 23/16; F01K 7/16; F01D 15/10; F01K 13/02; F05D 2220/31; F05D 2220/74; F05D 2220/76; F05D 2260/4023

(57) ABSTRACT

The invention relates to a method for operating a steam turbine, the steam turbine being accelerated to a nominal speed by a device, such as, for example, a gas turbine or a generator. The steam turbine is charged with steam only when the steam has certain steam parameters, until the steam has reached the certain steam parameters, where the steam turbine is accelerated to a rated speed by the device.

### CROSS REFERENCE TO RELATED APPLICATIONS

This application is the US National Stage of International Application No. PCT/EP2015/056345 filed Mar. 25, 2015, and claims the benefit thereof. The International Application claims the benefit of European Application No. EP14163721 filed Apr. 7, 2014. All of the applications are incorporated by reference herein in their entirety.

### FIELD OF INVENTION

The invention relates to a method for operating a steam turbine.

### BACKGROUND OF INVENTION

A steam turbine essentially comprises a rotor that is mounted so as to be able to rotate, and a casing arranged around the rotor.

Both the rotor and the casing are made of a suitable material and are very heavy. One of the consequences of this is that the steam turbine is relatively slow to heat up and to cool down.

Furthermore, steam turbines can be accelerated only once defined steam parameters of the steam that is supplied to the steam turbine have been reached. It can take several minutes—in some cases up to six minutes—for a steam turbine to reach its rated speed.

In combined-cycle power plants, a gas turbine is used, inter alia, to use the hot gas in a steam generator to generate steam for the steam turbine. In combined-cycle power plants of this type, the gas turbine is started first and the steam turbine is started only once defined steam parameters of the steam have been reached.

This takes a relatively long time. The quicker a power plant can be connected to a supply grid, the better.

### SUMMARY OF INVENTION

The invention aims to provide a remedy here. The invention therefore has an object of permitting rapid connection of a power plant to a supply grid.

This object is achieved with a method as claimed.

Advantageous developments are specified in the dependent claims.

The invention proceeds from the idea that the time required for accelerating the steam turbine can be saved if the steam turbine can be brought up to its rated speed before the necessary steam parameters have been reached.

The method is particularly well-suited to starting the steam turbine. The steam parameters α, β, γ, . . . are for example the pressure p=α, the temperature T=β, the pH value=γ. Only when the steam parameters reach a certain value, i.e. p=α>p₀=α₀, T=β>T₀=β₀, pH=γ>pH₀=γ₀, is the steam turbine charged with the steam. Up to the point of charging with steam, the steam turbine is accelerated by means of the device.

In a first advantageous development, the steam turbine is evacuated until the rated speed has been reached. In that context, a feed steam valve, which charges the steam turbine with steam, is closed. This avoids an acceleration power and endangerment by ventilation.

In another advantageous development, the invention provides that the device is designed as a gas turbine and torque is transmitted via a switchable clutch.

By setting the torque, the steam turbine can be accelerated to a rated speed at a desired time.

The rated speed is the speed at which, under full load, the steam turbine produces the greatest possible power, the rated power.

In particular embodiments, the rated speed is 25 Hz, 30 Hz, 50 Hz or 60 Hz.

In one advantageous development, the switchable clutch is designed as a hydrodynamic clutch.

The clutch can be designed as a clutch that establishes a frictionally engaged or electromagnetic connection.

In one advantageous development, a form fit can be established when the rated speed is reached in order to transmit all of the shaft power and to avoid slipping.

In a particularly advantageous development, the device is designed as a generator. This makes it possible, in particular in the case of multi-shaft plants, to accelerate the steam turbine to the rated speed. In this case, the generator serves as a motor and draws the power required therefor from the electrical grid.

In one advantageous development, the electrical grid used is the power plant grid.

The method according to the invention provides that the steam turbine is evacuated in order to avoid on one hand the acceleration power and on the other hand possible endangerment by ventilation.

The inventive method permits increased flexibility of the entire combined-cycle installation. By accelerating the steam turbine to the rated speed without steam, the invention makes provision for reducing the installation start-up times. This makes it possible for the steam turbine to take up direct power at the point of coming online.

Exemplary embodiments of the invention will be described hereinbelow with reference to the drawings. This is not to definitively show the exemplary embodiments, but rather the drawing, where conducive to clarification, is constructed in a schematized and/or slightly distorted form. With regard to additions to the teachings which are directly apparent in the drawing, reference is made to the relevant prior art.

### BRIEF DESCRIPTION OF THE DRAWINGS

In the drawings:

FIG. 1 shows a single-shaft combined-cycle plant,

FIG. 2 shows a two-shaft combined-cycle plant.

### DETAILED DESCRIPTION OF INVENTION

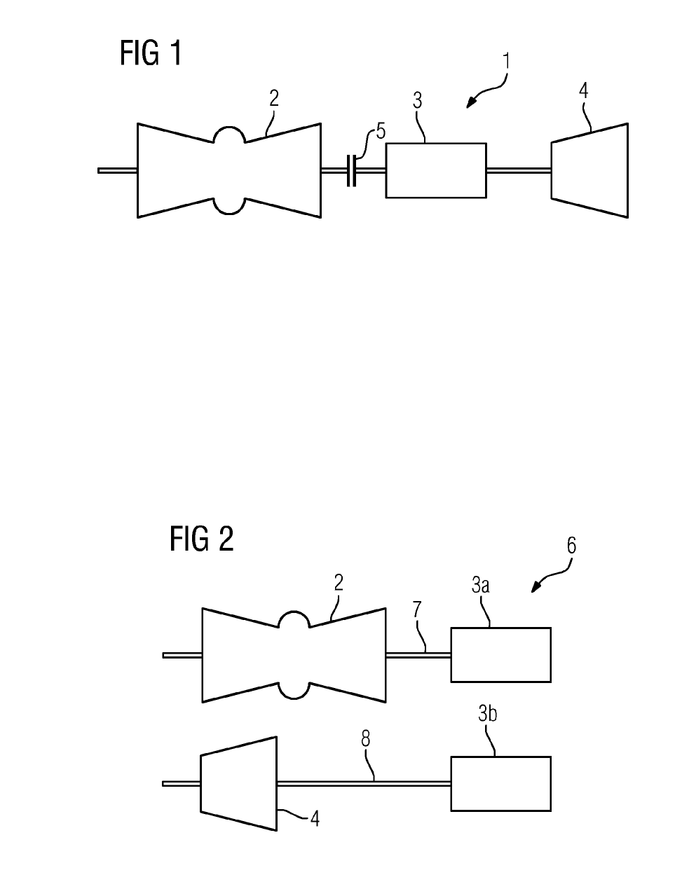

FIG. 1 shows a single-shaft combined-cycle plant 1 that comprises, fundamentally, a gas turbine 2, a generator 3 and a steam turbine 4. A clutch 5 is arranged between the gas turbine 2 and the generator 3. The clutch 5 serves to rotate and transmit and is designed to be switchable. The clutch 5 is designed as a hydrodynamic clutch.

The steam turbine 4 is charged with steam only when the steam has certain steam parameters α, β, γ, . . . The three steam parameters are described here by way of example. The steam parameters could for example be the temperature α=T, the pressure p=β, the pH value pH=γ. The certain steam parameters could be α=T₀, β=p₀, γ=pH₀. This means that the steam parameters represent values which, only once reached, lead to the steam turbine 4 being charged with steam. Until these steam parameters are reached, the steam turbine 4 is accelerated to the rated speed by means of the device.

In order to avoid acceleration power and on the other hand possible endangerment by ventilation, the steam turbine is evacuated until the rated speed has been reached.

In alternative embodiments, the clutch is designed as a clutch that establishes a frictionally engaged or electromagnetic connection.

For the sake of clarity, the full steam generation is not shown in greater detail.

In this context, the rated speed is 25 Hz, 30 Hz, 50 Hz or 60 Hz.

FIG. 2 shows a two-shaft combined-cycle plant 6. In this context, the gas turbine 3 is directly coupled to the generator 3a by a shaft 7. The steam turbine 4 is coupled to another generator 3b by a second shaft 8. With reference to FIG. 1, the steam turbine 4 is operated as follows: the steam turbine 4 is accelerated to a rated speed by means of a device, the device being the gas turbine 2. In that context, rotation is performed with transmission via the switchable clutch 5.

Once the rated speed has been reached, a form fit is established in the clutch 5.

With reference to the two-shaft embodiment of the combined-cycle power plant, the steam turbine 4 is accelerated to a rated speed by means of a device, the device being in this case the generator 3b. The necessary electrical power for the generator 3b is drawn from an electrical grid. In that case, the electrical grid used is the power plant grid.

Although the invention has been described and illustrated in detail by way of the preferred exemplary embodiment, the invention is not restricted by the disclosed examples and other variations can be derived herefrom by a person skilled in the art without departing from the scope of protection of the invention.

1. A method for operating a steam turbine (4), wherein the steam turbine (4) is charged with steam, wherein the steam has steam parameters α, β, γ, . . . , wherein the steam turbine (4) is charged with the steam only when the steam has certain steam parameters α, β, γ, . . . ,
Wherein, until the steam has reached the certain steam parameters α₀, β₀, γ₀, . . . , the steam turbine (4) is accelerated to a rated speed by means of a device.

2. The method as claimed in claim 1, wherein the steam turbine (4) is evacuated until the rated speed has been reached.

3. The method as claimed in claim 1 or 2, wherein the device is designed as a gas turbine (2) and torque is transmitted via a switchable clutch (5).

4. The method as claimed in claim 3, wherein the switchable clutch (5) is designed as a hydrodynamic clutch.

5. The method as claimed in claim 3 or 4, wherein a form fit is established in the clutch (5) once the rated speed is reached.

6. The method as claimed in claim 1 or 2, wherein the device is designed as a generator (3).

7. The method as claimed in claim 6, wherein the electrical power for the generator (3) is drawn from an electrical grid.

8. The method as claimed in claim 7, wherein the electrical grid used is the power plant grid.

9. The method as claimed in one of the preceding claims, wherein the rated speed is 25 Hz, 30 Hz, 50 Hz or 60 Hz.
